(19) United States
(12) Patent Application Publication
(10) Pub. No.: US 2005/0004689 A1
(43) Pub. Date: Jan. 6, 2005

(54) Design and control method of a micro-nanometer precision servo pneumatic X-Y positioning table

(76) Inventors: Ming-Chang Shih, Tainan City (TW); Kei-Pen Pai, Houbi Township (TW)

Correspondence Address: Ming-Chang Shih;No. 2, Alley 492, Hai Tian Rd. Sec. 2, Tainan City, TW

(21) Appl. No.: 10/614,674

(22) Filed: Jul. 2, 2003

(51) Int. Cl. G05B 19/18

(52) U.S. Cl. 700/63

(57) ABSTRACT

A micro-nanometer precision servo pneumatic X-Y positioning table comprises by two slide air cylinders and drives the two slide air cylinders by the servo control rule to make the pneumatic table to get the purpose of X-Y two degrees of freedom precision positioning. However, the pneumatic servo system is a high time-variant and nonlinear system and the nonlinear friction force; causes the stick-slip phenomenon of the servo pneumatic system. Therefore the. micro-nanometer precision servo pneumatic X-Y positioning table in accordance with the present invention has a new velocity feedback compensation method to overcome the nonlinear friction force and the stick-slip phenomenon. The new method is to add a velocity compensation signal, which periodic frequency is larger than the system's natural frequency into the control signals. The method is to put the velocity compensation signal directly into the servo valve control signals. By this method; it is able to avoid the complex control rules and the calculation of the feedback compensation and to get higher precision positioning. The positioning precision of the micro-nanometer servo pneumatic X-Y positioning table is about the resolution of the linear scale (ex. in this case 20 nanometer, is the resolution of the used optical linear scale; if the resolution is 10 nanometer the precision can be also 10 nanometer) not only for long stroke but also for micro-step command.

### BACKGROUND OF THE INVENTION

1. Field of the Invention

The present invention relates to a micro-nanometer precision servo pneumatic X-Y positioning table, and more particularly to a design of a micro-nanometer precision servo pneumatic X-Y two axes positioning table and a velocity compensation control method of overcoming the nonlinear friction force of the pneumatic cylinder and of eliminating the stick-slip phenomenon of the pneumatic servo system.

2. Description of the Related Art

A conventional pneumatic positioning table usually used the positioning pin, the photoelectric switch, or the magnetic switch to detect the position and lock the pneumatic cylinder. Those positioning methods are so hard to response the time difference accurately because of the time-variant and nonlinear character of the cylinder that it's hard to get high precision positioning. Recently the pneumatic servo valve is generally used to control the pneumatic servo system because of the improvement of the characteristic of the pneumatic servo valve and the development of the electronic control technology.

For a pneumatic servo positioning control system, a displacement sensor is set on the pneumatic cylinder; the sensor sends the displacement signals of the air cylinder back to the central processing unit to be the basis of the design of the controller. FIG. 1 is the block diagram of a PID servo pneumatic cylinder positioning control in accordance with the prior art. The pneumatic servo system is a time-variant and high nonlinear system as a result of the compressibility of the air and the friction force of the pneumatic cylinder. Therefore the pneumatic servo system is unable to have a higher positioning precision just by the linear PID control rule. Some academic researchers use the adaptive control rule, the fuzzy control rule or the artificial neural control rule to execute the positioning control of the servo pneumatic cylinder by,using velocity, acceleration or pressure signals compensation method. The positioning accuracy is between 0.1 mm and 0.03 mm. But the pneumatic servo system is a high nonlinear and time-variant system and the nonlinear friction force causes the stick-slip phenomenon of the pneumatic servo system, so that the conventional positioning control method isn't able to compensate the nonlinear friction force. For this reason, the position precision isn't able to be made a great breakthrough.

### SUMMARY OF THE INVENTION

A micro-nanometer precision servo pneumatic X-Y positioning table comprises by two slide air cylinders and drive the two slide air cylinders by servo control rule to make the pneumatic table to get the purpose of X-Y two degrees of freed precision positioning. However, the pneumatic servo system is a high time-variant and nonlinear system and the nonlinear friction force causes the stick-slip phenomenon of the pneumatic servo system. Therefore the micro-nanometer precision servo pneumatic X-Y positioning table in accordance with the present invention has a new velocity feedback compensation method to overcame the nonliner friction force and the stick-slip phenomenon. The new method is to add a velocity dither compensation signal, which frequency is larger than the system's natural frequency, into the control signals. The method is to put the velocity compensation signal directly into the servo valve control signals. By this method, instead of using the complex control rules and the calculation of the feedback compensation, one can get higher precision positioning. The positioning precision of the micro-nanometer precision servo pneumatic X-Y positioning table is about the resolution limit of the linear pulse scale (in this case 20 nm) not only for long stroke but also for micro-step command.

### BRIEF DESCRIPTION OF THE DRAWINGS

FIG. 1 is a block diagram of a PID servo pneumatic cylinder position control in accordance with the prior art;

FIG. 2 is a block diagram of the hardware of a micro-nanometer precision servo pneumatic X-Y positioning table and control method in accordance with the present invention;

FIG. 3 is a block diagram of the controller of a micro-nanometer precision servo pneumatic X-Y positioning table and control method in accordance with the present invention;

FIG. 4 is a characteristic curve diagram of a servo valve in accordance with the prior art;

FIG. 5 is a relationship diagram of the velocity and the friction force of an operating pneumatic cylinder in accordance with the prior art;

FIG. 6 is a method diagram of the decision of the velocity compensation signal in accordance with the present invention;

FIG. 7 is a control flow chart of the software of the micro-nanometer precision servo pneumatic X-Y positioning table and control method in accordance with the present invention;

FIG. 8 is the experimental results diagram of a micro-nanometer precision servo pneumatic X-Y positioning table in accordance with the present invention used for long stroke command, and

FIG. 9 is the experimental results diagram of a micro-nanometer precision servo pneumatic X-Y positioning table in accordance with the present invention used for micro-step command.

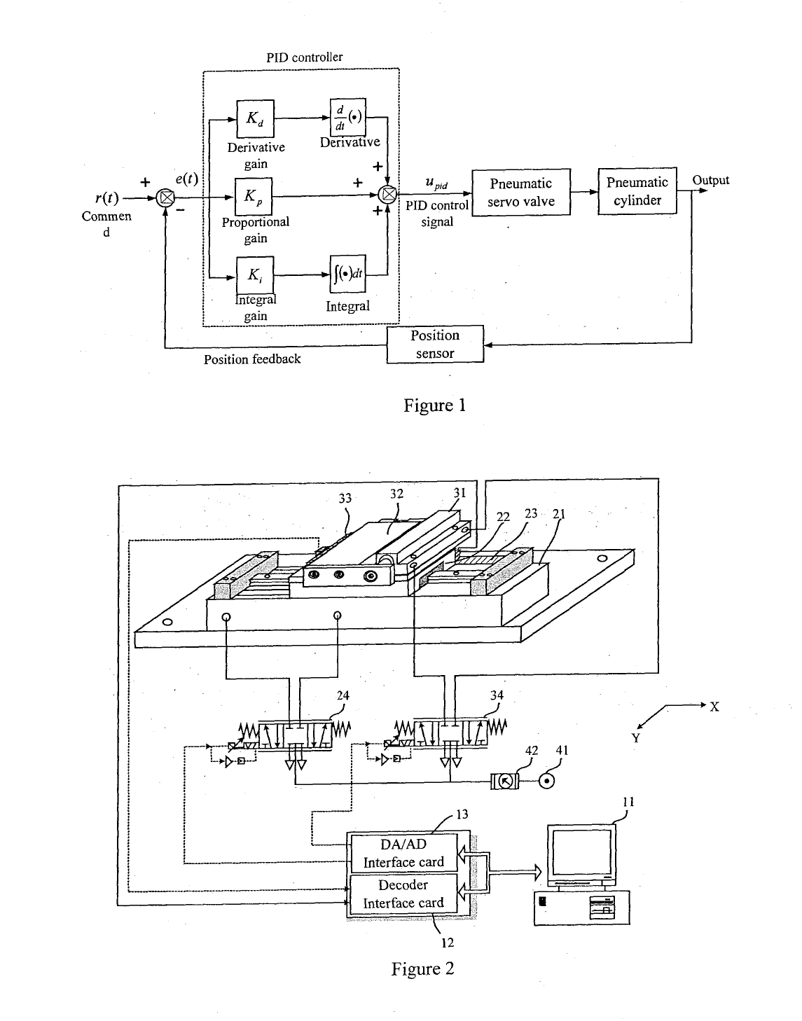

### DETAILED DESCRIPTION OF THE INVENTION

FIG. 2 is a block diagram of the hardware of a micro-nanometer precision servo pneumatic X-Y positioning table and the control compensation method in accordance with the present invention. The micro-nanometer precision servo pneumatic X-Y positioning table comprises by two slide air cylinders 21 & 31. The present invention is a pneumatic positioning table, which is able to move toward both X-axis and Y-axis. The slide air cylinder on the X-axis 21 has a positioning sensor optical scale 23 which resolution is micro-nanometer class (e.g. 1 um, 1 nm, 20 nm resolution) to measure the displacement of the positioning table on the X-axis 22. Put the slide air cylinder on the Y-axis 31 on the positioning table on the X-axis 22. The slide air cylinder on the Y-axis 31 has a positioning sensor, optical scale 33, which measure the displacement of the positioning table on the Y-axis 32. Therefore, the X-Y table is established, and then the positioning table on the Y-axis 32 is able to move toward both X-axis and Y-axis. The principle of the system's operation is as following: the industry computer 11 calculates the control signals for X-axis and Y-axis according to the errors and transfers the control signals to analog voltage signals by the digital/analog interface card 13. The analog output signals drive the servo valve 24 on the X-axis and the servo valve 34 on the Y-axis. The two servo valves 24 & 34 control the flow rate and direction of air into the two slide air cylinders 21 & 31 and make the positioning table on the Y-axis 32 move toward the expected position. The optical scale on the X-axis 23 and the optical scale on the Y-axis 33 measure the position of the two positioning table 21 & 31 and the decoder interface card 12 decodes the position signals, and then send them back to the industrial computer 11 to be treated. After calculation, the control signals are sent to the servo valve by the interface card 13 to complete the experiment.

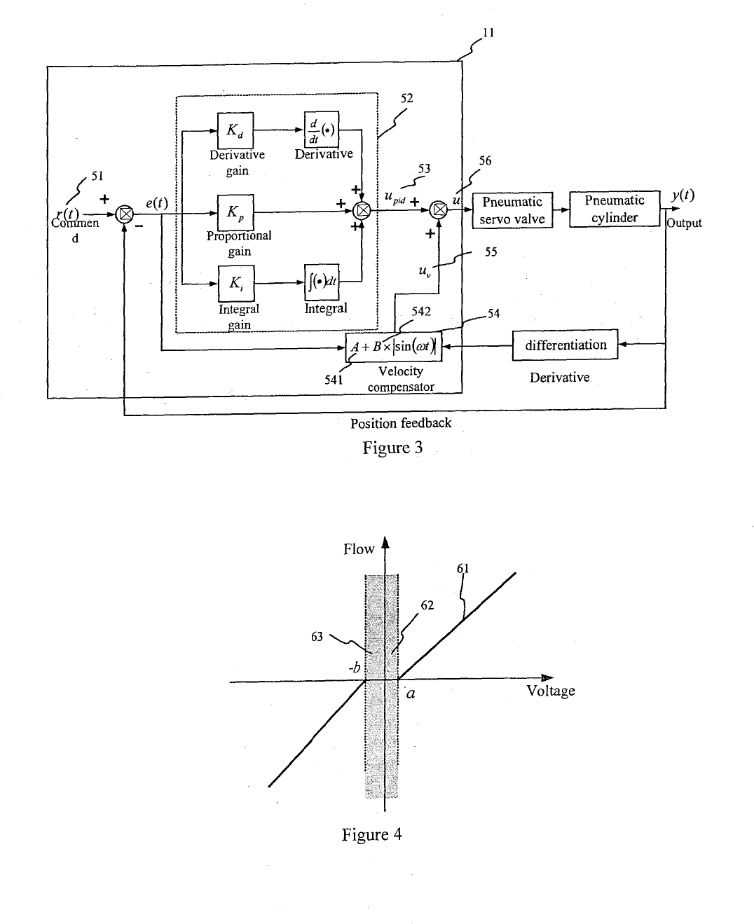

The positioning precision of every axis on the table depends on the design of the control signals of the industrial computer. FIG. 3 is a block diagram of the controller of the present invention. Referring to FIG. 3, the industrial computer compares the feedback position signals with the original command to get an error; the PID controller 52 calculates the error then sends a PID control signal 53. The pneumatic servo system is a high nonlinear and time-variant system and the non-linear friction force causes the stick-slip of the pneumatic servo system, therefore the present invention has a velocity compensator 54 to overcome the non-linear friction force and to eliminate the stick-slip phenomenon of the pneumatic servo system. The velocity compensator 54 outputs a velocity compensation signal 55 (uᵥ=A+B*|sin(ωt)|, which frequency is larger than the system's natural frequency, into the PID control signal 53. The velocity compensator 54 is designed according to the error and the velocity feedback signal.

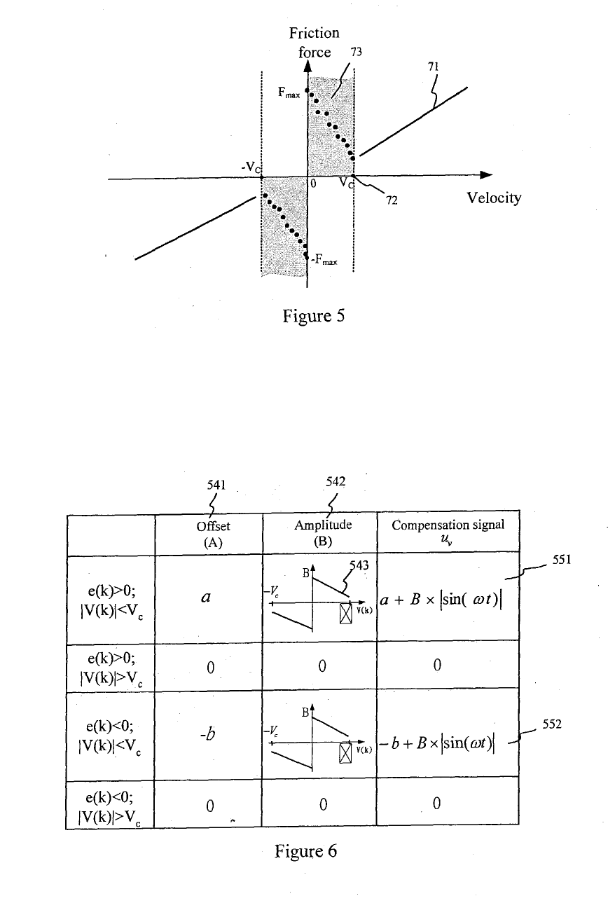

The offset (A) 541 and the amplitude (B) 542 are two parameters in the velocity compensation signal 55. They are decided according to the characteristic curve of the servo valve and the nonlinear friction force of the cylinder. FIG. 4 is a characteristic curve diagram of a servo valve in accordance with the prior art. Referring to FIG. 4, the characteristic curve of the servo valve 61 has a dead zone near the origin, and the drift of the zero point causes the unbalance phenomenon between positive dead zone of the servo valve 62 and the negative dead zone of the servo valve 63. In order to make the compensation signal having a better compensation effect between the positive dead zone and negative dead zone of the servo valve, make the value of the offset (A) 541 of the velocity compensation signal to be equal to the value of the dead zone of the servo valve. And the velocity compensation signal has a positive or negative offset compensation between positive and negative to avoid the dead zone of the servo valve. FIG. 5 is a relationship diagram of the velocity and the friction force of an operating pneumatic cylinder in accordance with the prior art. Referring to the characteristic curve of the velocity and the friction force of the pneumatic cylinder with high velocity 71, when the velocity gets slower and slower to approach the critical velocity (Vc) 72, the pneumatic cylinder has the stick-slip phenomenon. If the velocity is slower than the critical velocity (Vc) 72, the friction force of the pneumatic cylinder becomes immeasurable because of the stick-slip phenomenon, then the stick-slip phenomenon must be overcome through a compensation control signal for the sake of the precise positioning adjustment.

The present invention adjusts the amplitude (B) 542 of the velocity compensation signal according to the characteristic curve of the velocity and the friction force of the pneumatic cylinder with low velocity curve 73. Referring to the relationship of the velocity and the friction force of the pneumatic cylinder with low velocity curve 73, the friction force is in similar inverse proportion to the velocity until to the critical velocity (Vc) 72. Referring to FIG. 6, the amplitude curve 543 of the velocity compensation signal makes the amplitude in inverse proportion to the velocity according to the slope of the curve of the friction force of the pneumatic cylinder with low velocity curve 73. Therefore, the velocity compensation signal has larger amplitude to overcome the larger friction force of the pneumatic cylinder with the lower velocity. The value of the largest amplitude depends on the largest value of the friction force of the pneumatic cylinder. FIG. 6 is a compensation method diagram of the decision of the velocity compensation signal in accordance with the present invention. Referring to FIG. 6, the absolute value of the velocity of the operating pneumatic cylinder is larger than the critical velocity (Vc) 72, and the velocity compensation signal doesn't need to be compensated, under this condition A=0 and B=0. During the area, the pneumatic cylinder is far away from the objective and then control precision isn't affected. When the absolute value of the velocity of the operating pneumatic cylinder is smaller than the critical velocity (Vc) 72 and the error is positive, then the positive offset (A) 541 of the velocity compensation signal is decided and equal, to “a” and calculate the amplitude (B) 542 of the velocity compensation signal according to the curve of the amplitude 543 of the velocity compensation signal, then get the positive compensation 551. If the error is smaller than zero, then the negative offset (A) 541 of the velocity compensation signal is decided and equal to “−b” and calculate the amplitude (B) 542 of the velocity compensation signal according to the curve of the amplitude 543 of the velocity compensation signal, and then the negative compensation 552 is obtained.

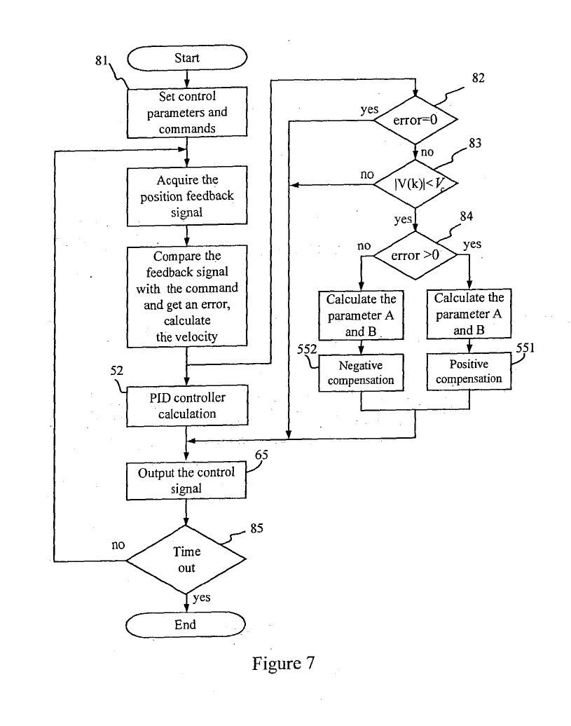

FIG. 7 is a control flow chart of the software of the micro-nanometer precision servo pneumatic X-Y positioning table and control method in accordance with the present invention. Referring to FIG. 7, at first, setting the parameters 81, which include the command 51, PID gain, the offset 541 of the velocity compensation signal between positive and negative, the largest amplitude of the velocity compensation signal, and the slope of the curve of the friction force of the pneumatic cylinder with low velocity curve 73. Next, start the pneumatic cylinder position table formally. The program acquires the feedback position signals and then compares the feedback signals with the original commands 51 to get an error and calculate the velocity. The PID control signal 53 is calculated according to the error through the designed PID controller 52. At the same time, judges the error is equal: to zero or not, 82. If the error is equal to zero, send the control output signal, 65, directly. If the error isn't equal to zero, judge the velocity is smaller than the critical velocity (Vc) 72 or not, 83. If the velocity is larger than the critical velocity (Vc) 72, send the control output signal, 65, directly. If the velocity isn't larger than the critical velocity (Vc) 72, judge the error is larger or smaller than zero. If the error is larger than zero, the positive offset (A) 541 of the velocity compensation signal is decided and equal to “a” and calculate the amplitude (B) 542 of the velocity compensation signal according to the characteristic curve of the amplitude of the velocity compensation signal, then get the positive compensation 551, and then send the control output signal, 65. If the error is smaller than zero, the negative offset (A) 541 of the velocity compensation signal is decided and equal to “−b” and calculate the amplitude (B) 542 of the velocity compensation signal according to the characteristic curve of the amplitude of the velocity compensation signal, then get the negative compensation 552, and then send the control output signal, 65. Finally, judge the time is out or not, 85. If the time is out, end the program; if the time isn't out, go back to the calculation of the PID controller 52, and execute next control signal until the time is out.

FIG. 8 is the experimental results of a micro-nanometer precision servo pneumatic X-Y positioning table in accordance with the present invention used in long stroke command.

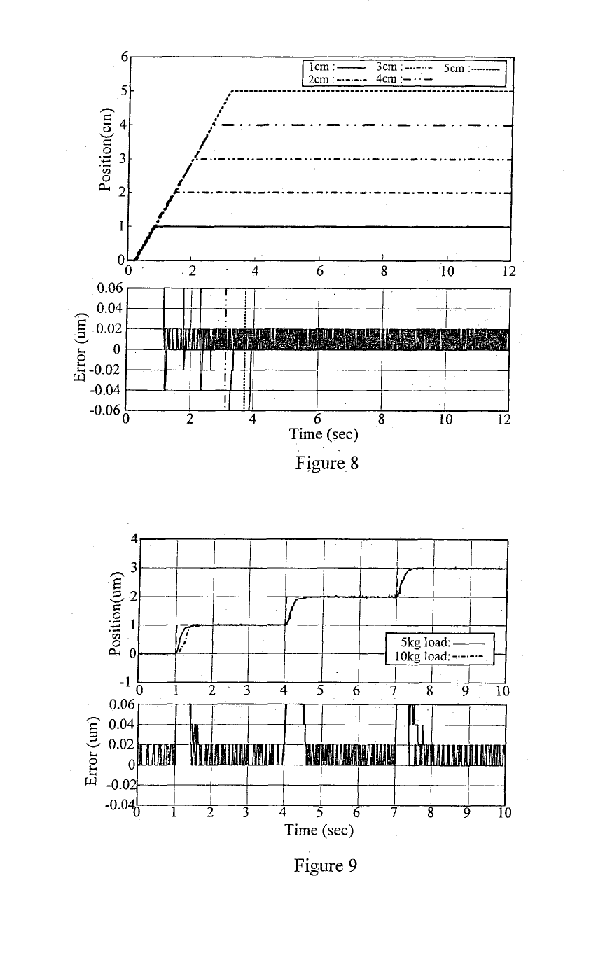

FIG. 9 is the experimental results diagram of a micro-nanometer precision servo pneumatic X-Y positioning table in accordance with the present invention used in micro-step command. The positioning precision is about 20 nm, which is the resolution of the applied linear optical scale.

To sum up, the compensation method of the micro-nanometer precision servo pneumatic X-Y positioning table in accordance with the present invention is able to not only overcome the influence from the nonlinear friction force to the positioning precision but also to make a great breakthrough in the positioning precision with the pneumatic cylinder.

1. A design and control method of a micro-nanometer precision servo pneumatic X-Y positioning table comprising:
a design of the precision servo pneumatic X-Y positioning table;
a compensation method of the velocity compensation signal used on the positioning control of the pneumatic cylinder, and a process of the positioning control method.

2. A design and control method of a micro-nanometer precision servo pneumatic X-Y positioning table in accordance with claim 1, wherein the said design of the precision servo pneumatic X-Y positioning table comprising:
two slide air cylinders drive the table;
a positioning sensor optical scale is used to send back the position signal, and then the system has the resolution of the micro-nanometer level;
an ordinary LVDT and resistance scales don't have the resolution of the micro-nanometer level, and a servo valve is also able to be replaced by a proportional valve.

3. A design and control method of a micro-nanometer precision servo pneumatic X-Y positioning table in accordance with claim 1, wherein the said compensation method of the velocity compensation signal comprising:
the decision of the waveform and the frequency of the velocity compensation signal, the frequency of the velocity compensation signal being larger than the system's natural frequency, and the waveform being the absolute value of sinusoidal wave signal and is able to be replaced by the square wave signal;
the decision of the amount of offset (A) of the velocity compensation signal depended on the characteristic curve of the servo valve; the value “a” of the positive dead zone of the servo valve being the positive offset of the velocity compensation signal, and the value “−b” of the negative dead zone of the servo valve being the negative offset of the velocity compensation signal;
the decision of the amplitude (B) of the velocity compensation signal depended on the characteristic curve of the velocity and the friction force of the pneumatic cylinder with low velocity; the slope of the curve of the friction force of the pneumatic cylinder with low velocity making the amplitude in inverse proportion to the velocity;
the decision of the largest amplitude of the velocity compensation signal depended on the largest friction force of the pneumatic cylinder; subtracting the value of the dead zone of the servo valve from the value of the smallest voltage of the pneumatic cylinder's slide and get the value of the largest amplitude, and
the velocity compensation signal being able to be used with servo valve control, besides, with proportion electromagnetic valve control or with high speed solenoid valve PWM control signal.

4. A design and control method of a micro-nanometer precision servo pneumatic X-Y positioning table in accordance with claim 1, wherein said process of the positioning control method comprising:
the judgment of the velocity being smaller than the critical velocity (Vc) or not, and decided to compensate or not, and
the judgment of the error being larger or smaller than zero, and decided to compensate the positive compensation or the negative compensation.
